(19) United States
(12) Patent Application Publication
(10) Pub. No.: US 2010/0088698 A1
(43) Pub. Date: Apr. 8, 2010

(54) TECHNIQUES FOR MANAGING COMMUNICATION SESSIONS

(76) Inventor: Ravishankar Krishnamurthy, Bangalore (IN)

Correspondence Address: SCHWEGMAN, LUNDBERG & WOESSNER/NOVELL, PO BOX 2938, MINNEAPOLIS, MN, 55402, US

(21) Appl. No.: 12/244,855

(22) Filed: Oct. 3, 2008

(51) Int. Cl. G06F 15/16; G06F 9/46

(52) U.S. Cl. 718/1; 709/229

(57) ABSTRACT

Techniques for managing communication sessions are provided. Secure communication sessions are authenticated via a third-party service and the authenticated responses are broadcasts to multiple virtual machines within a secure network. Each session associated with a principal that is accessing a protected resource of the secure network. The virtual machines assume ownership roles and backup roles for managing the communication session to provide failover support for the communication sessions and in some instances load balancing of the communication sessions.

### BACKGROUND

Networks are rapidly becoming overloaded and taxed with traffic from governments, organizations, and private individuals. In particular, the Internet is increasingly being used to conduct business, acquire information, and for leisure. Moreover, there have been recent governmental efforts made to ensure all participants within the United States have affordable access to high speed connectivity to the Internet. However, if every participant were to have a high speed connection to the Internet, then websites will become even more overtaxed and not be capable of supporting the increased speed with which transactions are received and processed.

To respond to this overtaxing situation, enterprises have replicated processing devices that can be used by users to access a particular enterprise service. So, when a user establishes a communication session with a particular enterprise service, the session is handled by one of many available devices that the enterprise uses to deliver that service.

The problem with this approach is that the user can become disconnected from the device, which the user is accessing, for a variety of reasons. For example, the user session can be idle for an extended period of time causing an automatic disconnect from the session and correspondingly the device. In another case, the device may experience network problems or may fail itself. In each case, the user is forced to manually establish a new session with the enterprise to access another device of the enterprise that delivers the service.

This is inconvenient for the user and creates a perception that the enterprise is not providing highly available services, which may cause the user to switch enterprises.

Thus, what is needed is a mechanism for improved management of communication sessions.

### SUMMARY

In various embodiments of the invention, techniques are presented for managing communication sessions. More specifically and in an embodiment, a method is provided for managing a communication session. An access authorization is detected; the access authorization is received from an identity service. The access authorization is also generated by the identity service in response to a request issued by a principal for access to a protected resource. The request is initially handled by a first virtual machine, which redirected the request to the identity service for authentication. Next, the access authorization is broadcasts within a secure network; the secure network includes the first virtual machine and second virtual machines. The first virtual machine and each of the second virtual machines are capable of servicing the request for access to the protected resource. Additionally, the access authorization includes a first virtual machine identifier and a first virtual machine assigned session identifier to uniquely identify a communication session between the principal and the protected resource. The communication session is to be initially handled by the first virtual machine.

### BRIEF DESCRIPTION OF THE DRAWINGS

FIG. 1 is a diagram of a method for managing a communication session, according to an example embodiment of the invention.

FIG. 2 is a diagram of another method for managing a communication session, according to an example embodiment of the invention.

FIG. 3 is a diagram of still another method 300 for managing a communication session, according to an example embodiment of the invention.

FIG. 4 is a diagram of a communication session management system, according to an example embodiment of the invention.

### DETAILED DESCRIPTION

A “resource” includes a user, content, a processing device, a node, a service, an application, a system, a schema definition, a directory, an operating system (OS), a file system, a data store, a database, a policy definition, a configuration definition, a file, content, a World-Wide Web (WWW) service, a WWW page, groups of users, a digital certificate, an attestation, combinations of these things, etc. The terms “service,” “application,” and “system” may be used interchangeably herein and refer to a type of software resource that includes instructions, which when executed by a machine (virtual or physical) performs operations that change the state of the machine and that may produce output.

A “principal” is a special type of resource that performs one or more actions against other resources. So a principal may be a user or an automated service. A principal also can authenticate for access to secure networks via the proper credentials. Authentication provides a unique identity for the principal within the context of the secure network.

A “processing environment” refers to one or more physical processing devices organized within a local network. For example, several computers connected via a local area network (LAN) may collectively be viewed as a processing environment. The processing environment also refers to software configurations of the physical processing devices, such as but not limited to operating system, file system, directory service, etc. A single processing environment may be logically defined, such that it spans multiple different networks (e.g., multiple different LAN's, a LAN and a wide-area network (WAN), etc.).

An “identity service” refers to a special type of service that is designed to manage and supply authentication services and authentication information for resources. So, an identity service may authenticate a given resource for access to a variety of local and external services being managed by that identity service. A single resource may have multiple identity services. In addition the identity service itself may be viewed as a type of resource. In this manner, identity service may authenticate and establish trust with one another viewing one another as specific type of resource.

According to an embodiment, some example identity services are described in “Techniques for Dynamically Establishing and Managing Authentication and Trust Relationships,” filed on Jan. 27, 2004, and having the U.S. Ser. No. 10/765,523; “Techniques for Establishing and Managing a Distributed Credential Store,” filed on Jan. 29, 2004, and having the U.S. Ser. No. 10/767,884; and “Techniques for Establishing and Managing Trust Relationships,” filed on Feb. 3, 2004, and having the U.S. Ser. No. 10/770,677; all of which are commonly assigned to Novell, Inc., of Provo, Utah and the disclosures of which are incorporated by reference herein.

An identity service may also provide single sign-on services to a resource. That is, a resource may sign-on to an identity service and acquire identities and credentials to access a variety of other services or resources. In some cases, the identity service is modified or enhanced to perform some of the teachings presented herein and below.

Again a resource is recognized via an “identity.” An identity is authenticated via various techniques (e.g., challenge and response interaction, cookies, assertions, etc.) that use various identifying information (e.g., identifiers with passwords, biometric data, hardware specific data, digital certificates, digital signatures, etc.). A “true identity” is one that is unique to a resource across any context that the resource may engage in over a network (e.g., Internet, Intranet, etc.). However, each resource may have and manage a variety of identities, where each of these identities may only be unique within a given context (given service interaction, given processing environment, given virtual processing environment, etc.).

Various embodiments of this invention can be implemented in existing network architectures, security systems, data centers, gateways, routers, bridges, proxies (reverse, transparent, and/or forward) and/or other network communication devices. Any particular architectural layout or implementation presented herein is provided for purposes of illustration and comprehension only and is not intended to limit aspects or embodiments of the invention.

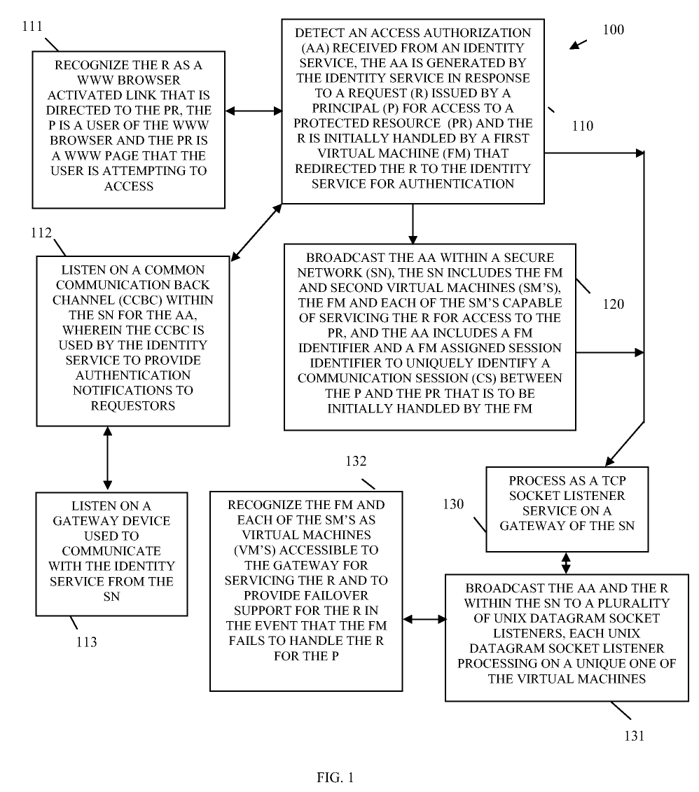

It is within this context, that various embodiments of the invention are now presented with reference to the FIGS. 1-4.

FIG. 1 is a diagram of a method 100 for managing a communication session, according to an example embodiment of the invention. The method 100 (hereinafter “port session broadcasting service”) is implemented as instructions in a machine-accessible and readable medium. The instructions when executed by a machine (computer or processor-enabled device) perform the processing depicted in FIG. 1. The port session broadcasting service is also operational over and processes within a network. The network may be wired, wireless, or a combination of wired and wireless.

At 110, the port session broadcasting service detects an access authorization received from an identity, such as one of the identity services discussed and incorporated by reference herein and above. The access authorization is generated by the identity service in response to a request issued by a principal. The principal makes the request for purposes of accessing a protected resource of a secure network.

A secure network is one in which access is restricted via some security mechanism. In some cases, this may entail using encrypted communication access as well as requiring successful authentication for any resource making access.

The request is initially handled by a first virtual machine that had redirected the request to the identity service from within the secure network for purposes of authenticating the principal and the request for access to the protected resource.

According to an embodiment, at 111, the port session broadcasting service recognizes the resource as a World-Wide Web (WWW) browser activated link. The activated link is directed to the protected resource by a user of the WWW browser. The user is the principal, in this embodiment, and the protected resource is a WWW page that the user is attempting to access by activating the link to that WWW page from within the WWW browser.

In another case, at 112, the port session broadcasting service listens on a common communication back channel within the secure network for the access authorization. The common communication back channel is used by the identity service to provide authentication notifications to requesters. In other words, the communication from the identity service to the secure network occurs via just the common communication back channel and this is where the port session broadcasting service listens to detect the access authentication.

Continuing with the embodiment at 112 and at 113, the port session broadcasting service listens on a gateway device used to communicate with the identity service from the secure network. The gateway device is a dedicated or logical device that provides communication bridging between the secure network and other networks, such as the Internet.

At 120, the port session broadcasting service broadcasts the access authorization within the secure network. The secure network includes the first virtual machine, which initiated the authentication of the request (and which caused the identity service to produce the access authorization for that request), and second virtual machines. The first virtual machine and each of the second virtual machines are capable of servicing the request for access to the protected resource.

Furthermore, the access authorization includes a first virtual machine identifier and a first virtual machine assigned session identifier. The first virtual machine identifier uniquely indicates that it is the first virtual machine of the secure network that set up a potential communication session and requested that the identity service authenticate the principal for access to the protected resource. The first virtual machine assigned session identifier is a unique session identifier within the context of a processing environment associated with the first virtual machine. So, session identifiers can clash between virtual machines of the first network but the combination of session identifiers along with virtual machine identifiers does not clash within the secure network and is unique.

In some cases, random numbers may also be generated and combined with the session identifiers and the virtual machine identifiers to ensure that each session is uniquely identified by all virtual machines of the secure network.

According to an embodiment, at 130, the port session broadcasting service and the processing depicted at 110-120 in FIG. 1 is processed as a Transmission Control Protocol (TCP) socket listener service on a gateway device of the secure network.

Continuing with the embodiment at 130 and at 131, the port session broadcasting service broadcasts the access authorization and the request within the secure network to a plurality of UNIX datagram socket listeners. Each UNIX datagram socket listener processes on a unique one of the virtual machines of the secure network.

Still continuing with the embodiments of 130 and 131 depicted at 132, the port session broadcasting service recognizes the first virtual machine and each of the second virtual machines as virtual machines processing on or accessible to the gateway device. Each virtual machine (VM) capable of servicing the request and capable of providing failover support for the request in the event that the first virtual machine fails to the handle the request for the principal during the communication session.

So, by broadcasting the access authorization, each of the virtual machines (including the first virtual machine) can identify which of them is the owner of the communication session and which of them are designated as backups to the communication session. The access authorization permits the second virtual machines to pick up and process the communication session without re-authentication and without losing the communication session that is established initially between the principal and the protected resource.

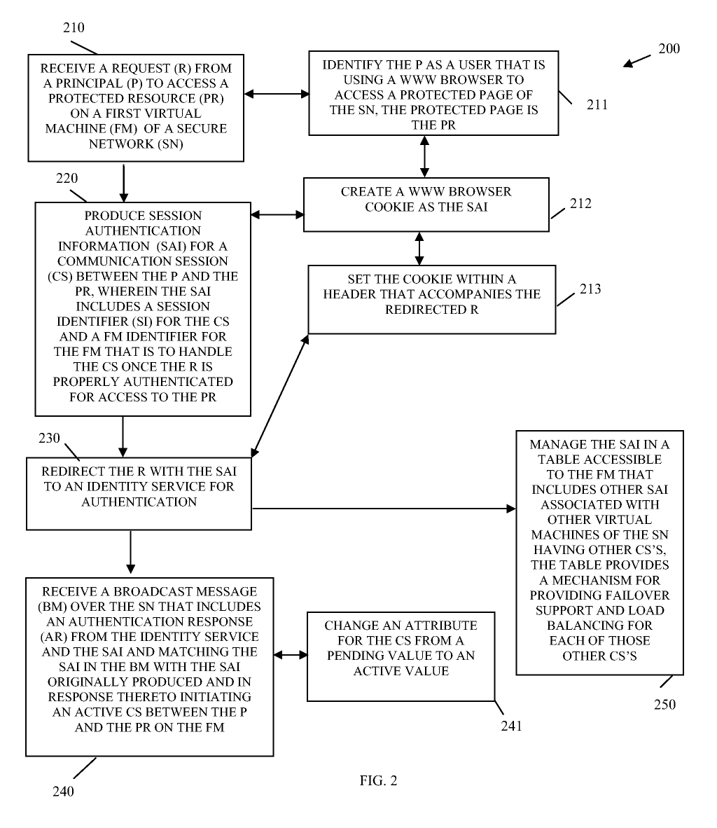

An example implementation is now provided for the port session broadcasting service along with other components that provide a novel mechanism for failover and load balancing session management (discussed in greater detail herein and below with reference to the FIGS. 2-4).

VM's are used to provide load balancing and fail-over mechanisms within a single Access Gateway machine, instead of using multiple Access Gateways. So, various embodiments herein teach techniques for sharing user sessions across multiple VM's in a single Access Gateway.

The Access Gateway can use different authentication mechanisms to authenticate the user and can maintain the user session using Hypertext Transfer Protocol (HTTP) cookies. Multiple VM's in the Access Gateway are used for load balancing the HTTP request;, the user may have been authenticated to one of the VMs, but later the requests from the same user session can go to an entirely different VM for processing. Hence, a mechanism is provided for sharing the user session across the VM's and effective failover from one VM to another without losing a user's session. So, embodiments discussed herein above and below discuss techniques for effectively load balancing and failover support for user sessions across multiple VM's in a single Access Gateway.

Consider a scenario, where multiple virtual machines are used in an Access Gateway for load balancing of HTTP requests. The Access Gateway can use an external identity service for authenticating the user. When the user tries to access a protected resource controlled by the Access Gateway, the Access Gateway does an HTTP redirection to the identity service for authentication. The user then authenticates at the identity service, and the identity service redirects the user back to Access Gateway page, and provides the authentication status to the Access Gateway through a back channel.

In this scenario, if there are multiple VM's running in an Access Gateway, the back-channel authentication status response received from the identity service is shared with all the VM's of the Access Gateway, because the user's request from the browser after authentication can reach any one of the VM's.

Consider another scenario, where a user was authenticated and being processed by one of the VM's using an HTTP cookie. The user may have been idle for sometime; or, perhaps the VM crashed due for some reason. So, new requests from the same user session are handled by a different VM without losing the user's sessions.

The embodiments herein provide an effective technique for sharing the user sessions to address the above-discussed scenarios.

When multiple VM's are running in an Access Gateway, a common back-channel listener (port session broadcasting service) is initiated on the Access Gateway for receiving or detecting an authentication response (access authentication) from the identity service. In a particular implementation, a Unix Datagram socket listener is created for each VM and a master TCP socket listener, which actually listens on the back-channel port and shares the response with all the VM's. The authentication response from the identity service first reaches the master TCP listener (port session broadcasting service), listening on the back-channel port, and then the master listener broadcasts the response to the UNIX datagram socket listeners of the individual VM's. Through this mechanism, each VM gets the authentication response (access authentication) from the identity service and they make their own copy of the user session data structures from the authentication response.

The sequence of processing proceeds as follows:
1. A browser accesses a protected resource, the request is being processed by (Virtual Machine #1 of the secure network (VM1).
2. VM1 creates the initial data structures for the proposed communication session; marks the data structure as authentication pending; creates a cookie and redirects the browser to identity service with the cookie set in the header. The cookie contains afield (VMId (VM identifier)), which identifies the VM that created the cookie.
3. The browser authenticates with the identity service and redirects the browser back to the Access Gateway and then sends the authentication response(access authentication) through the back-channel communication.
4. The back-channel master listener receives the authentication response and in turn broadcasts the response to all the VM's of the secure network.
5. The VM, which initially created the request, identifies that it already has a session structure marked as pending. It marks the session as authentication completed and initiates the session.
6. The other VM's create new session structures from the authentication response and mark the owner of the session as the VM1.
7. Now, the redirected request from browser after authentication, can reach either VM1 or any of the other VM's. In each particular situation, all the VM's have the session corresponding to the user (principal) and can serve the user with the requested page (protected resource).

Another situation involved here is potential cookie collision, since the cookie contains an index value to identify the user session associated with the cookie. To remedy this, each cookie structure or session metadata maintained by each of the VM's can appear as follows:

```
Cookie
{
    Index - an index value, which identifies user session from a global
    session table;
    VMid, - an id, which identifies the owner (VM) for the session;
    Zero or more Random numbers;
}
```

Under processing load, there can be multiple browser requests reaching the Access Gateway and load balanced by VM's. In this scenario, there is a high possibility that two or more VM's create the cookie with a same index value. When the VM gets the authentication response from identity service and tries to update/create the session structures, if the index value is the same, there could be confusion as to which session is appropriate, the authentication response should be associated the VMid to avoid the potential collision.

So, in this scenario the VM looks for the VMId, if the VMid is the VM's own id, the VM updates the existing session, otherwise, the VM creates a new session and stores the session in a sequential fashion (such as a linked list) at the same index value in a global session table.

FIG. 2 is a diagram of another method 200 for managing a communication session, according to an example embodiment of the invention. The method 200 (hereinafter “virtual machine (VM) session management service”) is implemented as instructions in a machine-accessible and computer-readable storage medium. The instructions when executed by a machine (computer or processor-enabled device) perform the processing depicted in FIG. 2. The VM session management service is also operational over and processes within a network. The network may be wired, wireless, or a combination of wired and wireless.

The method 100 of the FIG. 1 is presented from the perspective of receiving an access authentication from an identity service and broadcasting that access authentication to virtual machines throughout a secure network. The VM session management service is presented from the perspective of a particular, initial first virtual machine that initiates authentication of an initial principal's request to access a protected resource by redirecting that request to the identity service.

At 210, the VM session management service receives a request from a principal to access a protected resource on a first virtual machine of a secure network.

According to an embodiment, at 211, the VM session management service identifies the principal as a user that is using a WWW browser to access a protected page of the secure network. The protected page is the protected resource.

Continuing with the embodiment at 211 and at 212, the VM session management service creates a WWW browser cookie as the session authentication information (discussed below at 220).

Still continuing with the embodiments at 211 and 212, and at 213, the VM session management service sets the cookie within a header that accompanies the redirected request (discussed below at 230). This was also discussed above with reference to the example illustration that followed the discussion of the FIG. 1 for the method 100.

At 220, the VM session management service produces session authentication information for a communication session between the principal and the protected resource. The session authentication information includes a session identifier for the session and a first virtual machine identifier for the first virtual machine. The first virtual machine handles the session once the request is properly authenticated for access to the protected resource.

At 230, the VM session management service redirects the request with the session authentication information to an identity service for authentication.

According to an embodiment, at 240, the VM session management service subsequently receives a broadcast message over the secure network. The broadcast message includes an authentication response from the identity service and the session authentication information. The VM session management service matches the session authentication information in the broadcast message with the session authentication information originally produced and assuming a match initiates an active communication session between the principal and the protected resource on the first virtual machine. This is a situation where the VM session management service identifies the session of a principal (user) where the VM session management service is waiting for authentication and the VM session management service is the owner.

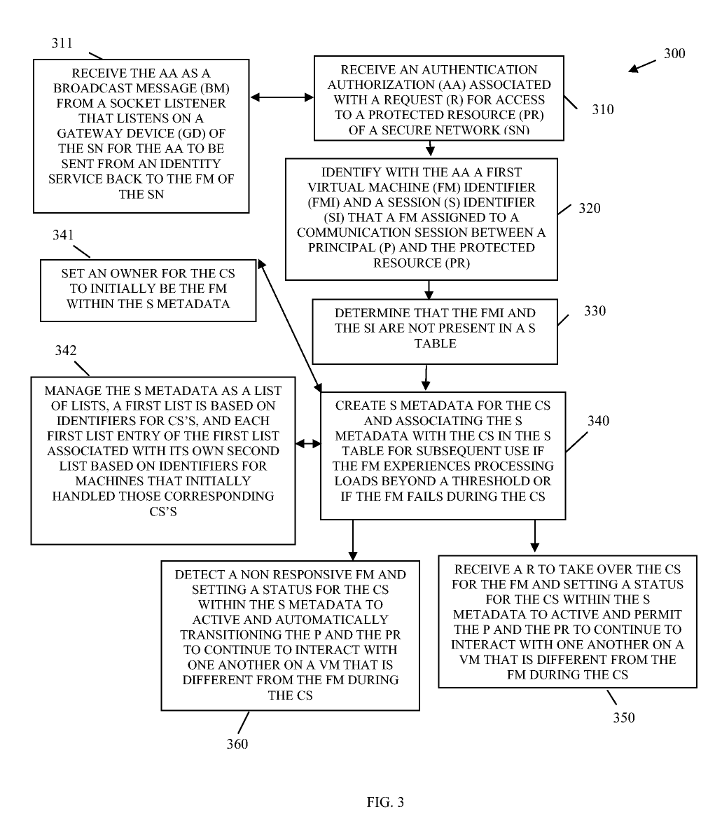

In another scenario, at 250, the VM session management service manages the session authentication information in a table, which is accessible to the first virtual machine and which includes other session authentication information associated with other virtual machines of the secure network having other communication sessions. The table provides a mechanism for providing failover support and load balancing for each of those other communication sessions. That is, the table permits the VM session management service to assume an existing communication session when a particular virtual machine fails or is experiencing heavy processing load. This is described in greater detail below with reference to the method 300 of the FIG. 3.

FIG. 3 is a diagram of a still another method 300 for managing a communication session, according to an example embodiment. The method 300 (hereinafter referred to as “session manager”) is implemented in a computer-readable storage medium as instructions, the instructions when executed by a machine (computer or processor-enabled device) performs the processing depicted with respect to the FIG. 3. The session manager is also operational over a network; the network can be wired, wireless, or a combination of wired and wireless.

The session manager presents the perspective of a virtual machine (such as a virtual machine of a gateway device) that does not initially own a principal (user or automated service) created session with a protected resource, where that session is authenticated and ready for use. The method 100 demonstrated how the authentication response is broadcast to virtual machines; the method 200 demonstrated how authentication is initiated and how sessions are owned initially; the method 300 (session manager) now demonstrates how those sessions are shared for purposes of load balancing and failover support.

At 310, the session manager receives an authentication authorization, which is associated with a request for access to a protected resource of a secure network.

According to an embodiment, at 311, the session manager receives the authentication authorization as a broadcast message from a socket listener that listens on a gateway device of the secure network for the authentication authorization to be sent from an identity service back to the first virtual machine of the secure network that initiated the authentication of the request.

At 320, the session manager identifies with the authentication authorization a first virtual machine identifier and a session identifier that the first virtual machine had assigned to a communication session between a requesting principal and the protected resource.

At 330, the session manager determines that the first virtual machine identifier and the session identifier are not present in a session table being managed by the session manager. This indicates that a new authenticated session that the session manager is unaware of is being initiated over the secure network for the principal and the protected resource and is initially be handled by the first virtual machine, which is not the virtual machine that the session manager is processing on and not the virtual machine or processing environment having the session table of the session manager.

At 340, the session manager creates session metadata for the communication session. The session manager associates the session metadata with the communication session in the session table for subsequent use if the first virtual machine experiences processing loads beyond a predefined threshold of if the first virtual machine fails during the communication session.

In an embodiment, at 341, the session manager sets an owner for the communication session to initially be the first virtual machine within the session metadata.

In another case, at 342, the session manager manages the session metadata as a list of lists. The first list is based on identifiers for communication sessions and each first list entry of the first list is associated with its own second list based on identifiers for virtual machines that initially handled those corresponding communication sessions.

In yet another situation, at 350, the session manager receives a request to take over the communication session fro the first virtual machine and sets a status for the communication session within the session metadata to active and permit the principal and the protected resource to continue to interact with one another on a virtual machine that is different from the first virtual machine during the communication session. Here, the communication session is essentially shared and picked up as needed by the session manager upon an indication that the session needs to be serviced and is not being properly serviced by the initial first virtual machine.

In an embodiment, at 360, the session manager detects a non-responsive first virtual machine and sets a status for the communication session with the session metadata to active. Next, the session manager automatically and dynamically transitions the principal and the protected resource to continue to interact with one another on a virtual machine that is different from the first virtual machine during the communication session. That particular virtual machine is the virtual machine that processes the session manager.

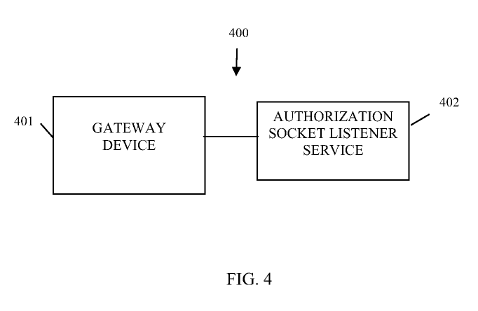

FIG. 4 is a diagram of a communication session management system 400, according to an example embodiment of the invention. The communication session management system 400 is implemented as instructions on or within a machine-accessible and computer-readable storage medium. The instructions when executed by a machine (computer or processor-enabled device) perform various aspects of the processing depicted with respect to the methods 100 and 200 of the FIGS. 1 and 2, respectively and the processing associated with the system 300 of the FIG. 3. The communication session management system 400 is also operational over a network and the network may be wired, wireless, or a combination of wired and wireless.

The communication session management system 400 includes a gateway device 401 and an authorization socket listener service 402. Each of these will now be discussed in turn.

The gateway device 401 may be a physical machine such as a server, proxy, router, etc. Alternatively, the gateway device 401 may be a logical machine, such as a VM, or even a service that processes as instructions on a physical machine. In an embodiment, the gateway device 401 permits protocol communication between different networks utilizing different protocols.

The authorization socket listener service 402 is implemented in a computer-readable storage medium and is to process on the gateway device 401 (when the gateway device 401 is a physical device) or within a processing context of the gateway device 401 (when the gateway device 401 is a logical device).

The authorization socket listener service 402 detects authentication authorizations for principals by listening on a specific port that an identity service uses to send the authentication authorizations. The principals have requested interaction to protected resources of the secure network. This action prompts the authentication to occur via the identity service and correspondingly the authentication authorizations to be sent by the identity service on the specific port.

The authorization socket listener service 402 broadcasts the authentication authorizations over the secure network to a plurality of virtual machines. The virtual machines cooperate to provide load balancing and failover support for communication sessions between the principals and the protected resources within the secure network.

According to an embodiment the plurality of machines are VM's. Furthermore, in some cases, the VM's process on the single gateway device 401. In some cases, each VM includes its own datagram socket listener that receives the broadcasts.

In a particular case, the specific port is a common back channel used for communication with the identity service within the secure network.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
detecting an access authorization received from an identity service, wherein the access authorization is generated by the identity service in response to a request issued by a principal for access to a protected resource and the request is initially handled by a first virtual machine that redirected the request to the identity service for authentication; and
broadcasting the access authorization within a secure network, the secure network includes the first virtual machine and second virtual machines, the first virtual machine and each of the second virtual machines capable of servicing the request for access to the protected resource, and wherein the access authorization includes a first virtual machine identifier and a first virtual machine assigned session identifier to uniquely identify a communication session between the principal and the protected resource that is to be initially handled by the first virtual machine.

2. The method of claim 1 further comprising, processing the method as a Transmission Control Protocol (TCP) socket listener service on a gateway of the secure network.

3. The method of claim 2, wherein broadcasting further includes broadcasting the access authorization and the request within the secure network to a plurality of UNIX datagram socket listeners, each UNIX datagram socket listener processing on a unique one of the virtual machines.

4. The method of claim 3 further comprising recognizing the first virtual machine and each of the second virtual machines as virtual machines accessible to the gateway for servicing the request and to provide failover support for the request in the event that the first virtual machine fails to handle the request for the principal.

5. The method of claim 1, wherein detecting further includes recognizing the request as a World-Wide Web (WWW) browser activated link that is directed to the protected resource, wherein the principal is a user of the WWW browser and the protected resource is a WWW page that the user is attempting to access.

6. The method of claim 1, wherein detecting further includes listening on a common communication back channel within the secure network for the access authorization, wherein the common communication back channel is used by the identity service to provide authentication notifications to requesters.

7. The method of claim 6, wherein listening further includes listening on a gateway device used to communicate with the identity service from the secure network.

8. A machine-implemented method, comprising:
receiving a request from a principal to access a protected resource on a first virtual machine of a secure network;
producing session authentication information for a communication session between the principal and the protected resource, wherein the session authentication information includes a session identifier for the communication session and a first virtual machine identifier for the first virtual machine that is to handle the communication session once the request is properly authenticated for access to the protected resource; and
redirecting the request with the session authentication information to an identity service for authentication.

9. The method of claim 8 further comprising, receiving a broadcast message over the secure network that includes an authentication response from the identity service and the session authentication information and matching the session authentication information in the broadcast message with the session authentication information originally produced and in response thereto initiating an active communication session between the principal and the protected resource on the first virtual machine.

10. The method of claim 9, wherein matching further includes changing an attribute for the communication session from a pending value to an active value.

11. The method of claim 8, wherein receiving further includes identifying the principal as a user that is using a World-Wide Web (WWW) browser to access a protected page of the secure network, wherein the protected page is the protected resource.

12. The method of claim 11, wherein producing further includes creating a WWW browser cookie as the session authentication information.

13. The method of claim 12, wherein redirecting further includes setting the cookie within a header that accompanies the redirected request.

14. The method of claim 8 further comprising, managing the session authentication information in a table accessible to the first virtual machine that includes other session authentication information associated with other virtual machines of the secure network having other communication sessions, wherein the table provides a mechanism for providing failover support and load balancing for each of those other communication sessions.

15. A machine-implemented method, comprising:
receiving an authentication authorization associated with a request for access to a protected resource of a secure network;
identifying with the authentication authorization a first virtual machine identifier and a session identifier that a first virtual machine assigned to a communication session between a principal and the protected resource;
determining that the first virtual machine identifier and the session identifier are not present in a session table; and
creating session metadata for the communication session and associating the session metadata with the communication session in the session table for subsequent use if the first virtual machine experiences processing loads beyond a threshold or if the first virtual machine fails during the communication session.

16. The method of claim 15, wherein receiving further includes receiving the authentication authorization as a broadcast message from a socket listener that listens on a gateway device of the secure network for the authentication authorization to be sent from an identity service back to the first virtual machine of the secure network.

17. The method of claim 15, wherein creating further includes setting an owner for the communication session to initially be the first virtual machine within the session metadata.

18. The method of claim 15, wherein creating further includes managing the session metadata as a list of lists, wherein a first list is based on identifiers for communication sessions, and each first list entry of the first list associated with its own second list based on identifiers for virtual machines that initially handled those corresponding communication sessions.

19. The method of claim 15 further comprising, receiving a request to take over the communication session for the first virtual machine and setting a status for the communication session within the session metadata to active and permitting the principal and the protected resource to continue to interact with one another on a virtual machine that is different from the first virtual machine during the communication session.

20. The method of claim 15 further comprising, detecting a non responsive first virtual machine and setting a status for the communication session within the session metadata to active and automatically transitioning the principal and the protected resource to continue to interact with one another on a virtual machine that is different from the first virtual machine during the communication session.

21. A machine-implemented system, comprising:
a gateway device processing as an intermediary between a secure and insecure network; and
an authorization socket listener service implemented in a computer-readable storage medium and to process on the gateway device;
wherein authorization socket listener service detects authentication authorizations for principals by listening on a specific port that an identity service uses to send the authentication authorizations, wherein the principals have requested interaction to protected resources of the secure network, which prompts authentication to occur via the identity service and the authentication authorizations to be sent on the specific port, and wherein the authorization socket listener service broadcasts the authentication authorizations over the secure network to a plurality of virtual machines, and wherein the virtual machines cooperate to provide load balancing and failover service for communication sessions between the principals and the protected resources within the secure network.

22. The system of claim 21, wherein the virtual machines process on the gateway device.

23. The system of claim 22, wherein each virtual machine includes its own datagram socket listener that receives the broadcasts.

24. The system of claim 22, wherein the specific port is common back channel used for communication with the identity service within the secure network.
